(19) United States
(12) Patent Application Publication
(10) Pub. No.: US 2022/0243531 A1
(43) Pub. Date: Aug. 4, 2022

(54) LADDER STABILIZATION ASSEMBLY, SYSTEM, AND METHOD OF USING THE SAME

(71) Applicant: Kelly Currie, Russell, IA (US)

(72) Inventor: Kelly Currie, Russell, IA (US)

(21) Appl. No.: 17/591,382

(22) Filed: Feb. 2, 2022

Related U.S. Application Data
(60) Provisional application No. 63/144,648, filed on Feb. 2, 2021.

(51) Int. Cl. E06C 7/10; E06C 7/46

(52) U.S. Cl. CPC E06C 7/10; E06C 7/46

(57) ABSTRACT

The disclosure provided herein is directed to a ladder stabilizer assembly. The ladder stabilizer assembly comprises one or more cross bars that are each configured to be received through and within the enclosed space of a ladder. At least one stake is received through the one or more cross bars to secure the ladder stabilizer assembly and the ladder to a ground surface during use.

### CROSS REFERENCE TO RELATED APPLICATION

This application claims the benefit of U.S. Provisional Application Ser. No. 63/144,648 filed Feb. 2, 2021, the contents of this application is hereby incorporated by reference in its entirety.

### BACKGROUND OF THE INVENTION

This disclosure generally relates to a ladder stabilizer. More specifically, and without limitation, this invention relates to ladder stabilizer assembly to physically secure a ladder to a ground surface.

Ladders and devices to stabilize ladders are well known in the art. Injuries from ladders, however, continue to be a significant problem. According to the World Health Organization, more than 300 related deaths occur in the U.S. as the result of individuals falling from ladders. Falling ten feet or less from a ladder can result in death and it is unsurprising that falls from ladders continues to be a leading cause of death on construction sites. While annual numbers vary, it is not unheard of for more than 150,000 injuries to occur that require an emergency room visit for treatment, while hundreds of thousands more require medical treatment.

To address the risks associated with using a ladder, a number of advancements have taken place. One example is the use of a ladder level, which is an extension attached to the bottom of a ladder's side rails to provide stability on an uneven ground surface. While useful, the application of the device is not universal and in general, it is advisable to place a ladder on a level surface. Such devices also have the drawback of being essentially without utility in the event that an individual loses their balance and topple from the ladder as the ladder shifts with the individual's weight.

Another related advancement is the use of a telescoping pin that extends from the side rails. Like level ladders, the usefulness of such devices is limited and their use promotes dangerous positioning of a ladder. Furthermore, such telescoping pins are none to fault, resulting in harm.

Other advancements have taken place to stabilize ladders. These include the use of stabilizer arms that are generally U-shaped and attached near the top of a ladder. Such devices enhance stability of the ladder, but significant jarring of the ladder like that caused by an individual losing their balance can still result in the ladder, and the individual, falling as the ladder teeters under the shifting weight of the individual. Additionally, if an individual loses their balance and pulls on the ladder to regain their balance, it is possible that the individual can pull the ladder backwards so that the ladder falls on top of the individual, enhancing the degree of injury.

Considering the deficiencies present in the art, it is a primary objective of this invention to provide a ladder stabilizer assembly and system that improves upon the art.

Another aspect of this invention is to provide a ladder stabilizer assembly that works with a variety of ladder types.

Yet another aspect of this invention is to provide a ladder stabilizer assembly that anchors a ladder in place.

Another aspect of this invention is to provide a ladder stabilizer assembly that increases safety of using a ladder, including while alone.

Yet another aspect of this invention is to provide a ladder stabilizer assembly that resists rocking and pulling.

Another aspect of this invention is to provide a ladder stabilizer assembly that is easy to transport and store.

Yet another aspect of this invention is to provide a ladder stabilizer assembly that is removable from a ladder.

Another aspect of this invention is to provide a ladder stabilizer assembly that can retrofit a conventional ladder.

Yet another aspect of this invention is to provide a ladder stabilizer assembly that is easy to use.

These and other aspects, features, and advantages of the invention will become apparent from the specification and claims.

### SUMMARY OF THE INVENTION

The disclosure provides various aspects of a ladder stabilizer assembly.

In one aspect of the disclosure, broadly described herein, the assembly described herein relates to a first cross bar having a first opening and a second opening, wherein the first cross bar is configured to be received through a first rung of a ladder; a second cross bar having a first opening and a second opening, wherein the second cross bar is configured to be received through a second rung of the ladder; a first stake rotatably received within the first opening of the first cross bar and the first opening of the second cross bar; wherein the first stake has a first handle portion; and a second stake rotatably received within the second opening of the first cross bar and the second opening of the second cross bar; wherein the second stake has a second handle portion.

In another aspect of the disclosure, broadly described herein, the assembly described herein relates to the first stake and the second stake each have a generally L-shape formed by a curved portion extending between a shaft portion and the handle portion of the first stake and the second stake, respectively.

In another aspect of the disclosure, broadly described herein, the assembly described herein relates to the first opening of the first cross bar and the first opening of the second cross bar are in alignment; and the second opening of the first cross bar and the second opening of the second cross bar are in alignment.

In another aspect of the disclosure, broadly described herein, the assembly described herein relates to the first cross bar and the second cross bar have substantially the same size and shape.

In another aspect of the disclosure, broadly described herein, the assembly described herein relates to the first stake and the second stake have substantially the same size and shape.

In another aspect of the disclosure, broadly described herein, the assembly described herein relates to the first stake and the second stake each converge to a point, wherein the point is configured to break a ground surface.

In another aspect of the disclosure, broadly described herein, the assembly described herein relates to the first cross bar has a first threaded portion that extends from a first terminal end towards a second terminal end, and a second threaded portion that extends from the second terminal end to the first terminal end.

In another aspect of the disclosure, broadly described herein, the assembly described herein relates to the second cross bar has a first threaded portion that extends from a first terminal end towards a second terminal end, and a second threaded portion that extends from the second terminal end to the first terminal end.

In another aspect of the disclosure, broadly described herein, the assembly described herein relates to a first retention assembly adjustably connected adjacent a first terminal end of the first cross bar and a second retention assembly connected adjacent a second terminal end of the first cross bar.

In another aspect of the disclosure, broadly described herein, the assembly described herein relates to a spacer positioned on the first cross bar and configured to occupy a space between the first cross bar and a space within an enclosed passageway of the first rung of the ladder.

In another aspect of the disclosure, broadly described herein, the assembly described herein relates to the first retention assembly comprises a washer and a nut, wherein the nut is adjustably and threadably connected to a threaded portion extending from a first terminal end of the first cross bar.

In another aspect of the disclosure, broadly described herein, the assembly described herein relates to a third retention assembly adjustably connected to adjacent a first terminal end of the second cross bar and a fourth retention assembly connected adjacent a second terminal end of the second cross bar.

In another aspect of the disclosure, broadly described herein, the assembly described herein relates to the first retention assembly, the second retention assembly, the third retention assembly, and the fourth retention assembly are configured to be affixed in an abutting arrangement against opposing sides of a ladder such that the first cross bar and the second cross bar are retained in a fixed position in relation to the ladder.

In another aspect of the disclosure, broadly described herein, the assembly described herein relates to one of a plurality of caps attached to each of a first terminal and a second terminal end of the first cross bar, and a first terminal end and a second terminal end of the second cross bar; wherein the plurality of caps comprise a flexible and cushioning material.

In another aspect of the disclosure, broadly described herein, the assembly described herein relates to the first cross bar and the second cross bar have a length of approximately 24.0 inches.

In another aspect of the disclosure, broadly described herein, the assembly described herein relates to the first opening of the first cross bar is configured to receive the first stake with a tolerance of 0.0625 inches between the first stake and the first cross bar.

In another aspect of the disclosure, broadly described herein, the assembly described herein relates to the first stake has a shaft portion that measures between approximately 44.0 inches and 45.0 inches.

In another aspect of the disclosure, broadly described herein, the assembly described herein relates to the first stake has a handle portion having a length of approximately 4.0 inches such that the handle portion is configured to be received within a third rung of the ladder when the first stake is raised above a terminal end of the ladder.

This has outlined, rather broadly, the features, advantages, solutions, and benefits of the disclosure in order that the description that follows may be better understood. Additional features, advantages, solutions, and benefits of the disclosure will be described in the following. It should be appreciated by those skilled in the art that this disclosure may be readily utilized as a basis for modifying or designing other structures and related operations for carrying out the same purposes of the present disclosure. It should also be realized by those skilled in the art that such equivalent constructions and related operation do not depart from the teachings of the disclosure as set forth in the appended claims. The novel features, together with further objects and advantages, will be better understood from the following description when considered in connection with the accompanying Figures. It is to be expressly understood, however, that each of the Figures is provided for the purpose of illustration and description only and is not intended as a definition of the limits of the present disclosure.

### BRIEF DESCRIPTION OF THE DRAWINGS

FIG. 1 is a perspective view of a ladder known in the art;

FIG. 2 is a front view of a ladder stabilizer assembly according to an aspect of the disclosure;

FIG. 3 is a front view of a ladder stabilizer assembly according to an aspect of the disclosure; and

FIG. 4 is a front view of a ladder stabilizer assembly according to an aspect of the disclosure.

### DETAILED DESCRIPTION

The disclosure described herein is directed to different aspects of a ladder stabilizer assembly. The detailed description set forth below, in connection with the appended drawings, is intended as a description of various configurations and is not intended to represent the only configurations in which the concepts described herein may be practiced. These descriptions include specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

The disclosure is described herein with reference to certain aspects, iterations, embodiments, and examples but it is understood that the disclosure can be embodied in many different forms and should not be construed as limited to the aspects set forth herein.

Although the terms first, second, etc. may be used herein to describe various elements or components, these elements or components should not be limited by these terms. These terms are only used to distinguish one element or component from another. Hence, a first element discussed herein could be termed a second element without departing from the teachings of the present application. It is understood that actual systems or fixtures embodying the disclosure can be arranged in many different ways with many more features and elements beyond what is shown in the drawings. For the same or similar elements or features, the same reference numbers may be used throughout the disclosure.

It is to be understood that when an element or component is referred to as being “on” another element or component, it can be directly on the other element or intervening elements may also be present. Furthermore, relative terms such as “between”, “within”, “below”, and similar terms, may be used herein to describe a relationship of one element or component to another. It is understood that these terms are intended to encompass different orientations of the disclosure in addition to the orientation depicted in the figures.

Aspects of the disclosure may be described herein with reference to illustrations that are schematic illustrations. As such, the actual thickness of elements can be different, and variations from the shapes of the illustrations as a result, for example, of manufacturing techniques and/or tolerances are expected. Thus, the elements illustrated in the figures are schematic in nature and their shapes are not intended to illustrate the precise shape of a region of a device and are not intended to limit the scope of the disclosure.

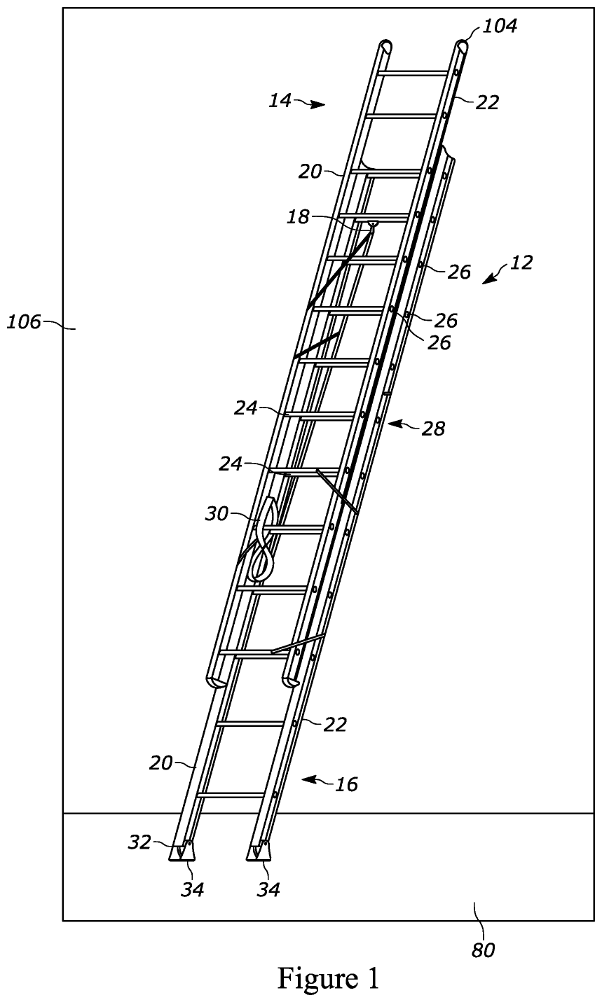

With reference to the Figures aspects of a ladder stabilizer assembly 10 for use in a system with a ladder 12 are shown according to the disclosure. While the present description discusses use of the ladder stabilizer assembly 10 being used with an extension style type of ladder 12, other ladders 12 fall within the scope and spirit of the present invention, including a step ladder, single ladder, articulated ladder, tripod ladder, trestle ladder, and telescoping ladder. Though the particular features of the ladder 12 may vary depending on type, the ladder 12 provided for in the present application and seen in FIG. 1 has a fly section 14 and base section 16, which are operatively connected to one another, such as by a rope and pulley system 18, so that the fly section 14 can be raised and lowered in relation to the base section 16 so that an individual can select the overall height of the ladder 12.

Both the fly section 14 and the base section 16 of the ladder 12 have a first side rail 20 and a second side rail 22 with a plurality of rungs or steps 24 extending therebetween. The plurality of rungs 24 are hollow and the first side rail 20 and the second side rail 22 of both the fly section 14 and the base section 16 have openings 26 where each rung 24 connects to the respective side rail 20 and 22. In this way, an enclosed passageway 28 extends through each of the rungs 24 and the first side rail 20 and the second side rail 22.

Some aspects of the ladder 12 include a rung lock 30 to prevent the fly section 14 from collapsing when extended in relation to the base section 16. Attached to the bottom terminal end 32 of each of the first side rail 20 and the second side rail 22 of the base section 16 is a safety foot or anti-slip shoe 34.

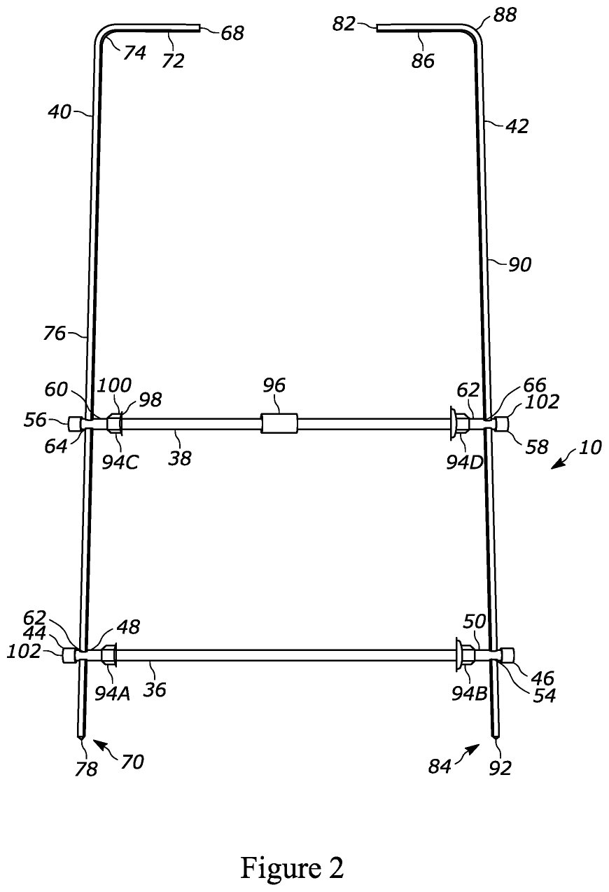

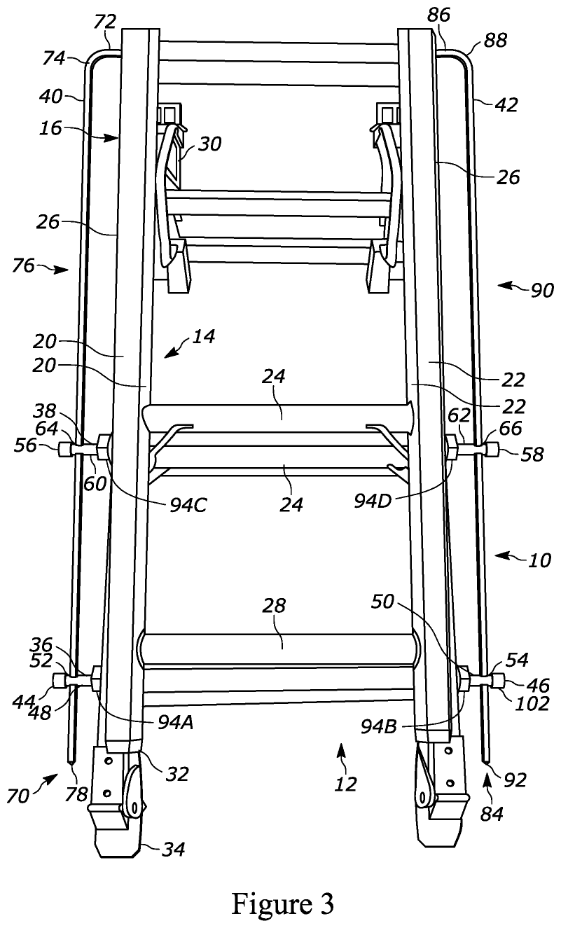

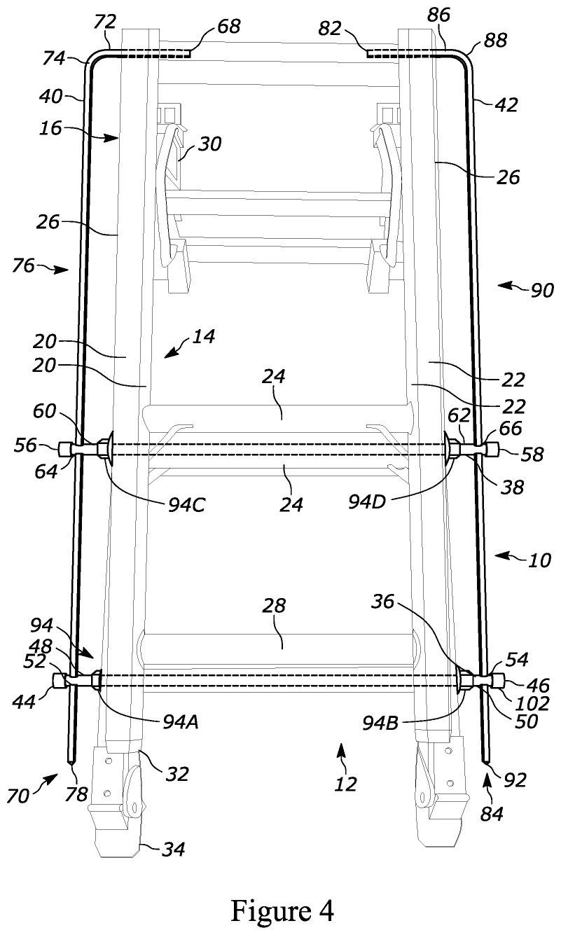

As seen in FIGS. 2-4, the ladder stabilizer assembly 10 comprises a first cross bar 36 and a second cross bar 38 that receive at least a first stake 40 and, in some aspects of the present invention, a second stake 42. In some aspects, the size and shape of the first cross bar 36 and the second cross bar 38 are identical or substantially identical in order to facilitate assembly with the ladder 12 as described further herein. Likewise, in some arrangements of the present invention, the size and shape of the first stake 40 and/or the second stake 42 are identical or substantially identical in order to facilitate assembly and use as described further herein. The first cross bar 36 extends from and between a first or one terminal end 44 to a second or opposing terminal end 46. In some aspects, the first cross bar 36 has a first threaded portion 48 extending from the first terminal end 44 towards the second terminal end 46 and a second threaded portion 50 extending from the second terminal end 46 towards the first terminal end 44. In another aspect, adjacent the first terminal end 44 is a first opening 52 and adjacent the second terminal end 46 is a second opening 54. The first opening 52 and second opening 54 extend through the first cross bar 36 along parallel axes in some aspects of the present invention.

The second cross bar 38 extends from and between a first or one terminal end 56 to a second or opposing terminal end 58. In some aspects, the second cross bar 38 has a first threaded portion 60 extending from the first terminal end 56 towards the second terminal end 58 and a second threaded portion 62 extending from the second terminal end 58 towards the first terminal end 56. Adjacent the first terminal end 56 is a first opening 64 and adjacent the second terminal end 58 is a second opening 66 in some aspects of the ladder stabilizer assembly 10. In other aspects, the first opening 64 and second opening 66 extend through the second cross bar 38 along parallel axes. As seen in the exemplary embodiment of the Figures, some aspects of the present invention have the first opening 52 of the first cross bar 36 in alignment with the first opening 64 of the second cross bar 38 such that an axis extends through both. Likewise, in some aspects, the second opening 54 of the first cross bar 36 is in alignment with the second opening 66 of the second cross bar 38. In some instances of the present invention, the first cross bar 36 and the second cross bar 38 have a diameter of 0.75 or approximately 0.75 inches.

The first stake 40 extends from and between a first or one terminal end 68 to a second or opposing terminal end 70. The first stake 40, in some aspects, has a generally L-shaped configuration, which assists with insertion, rotation, and storage as described further herein. In instances of the present invention having an L-shaped configuration as well as other aspects, a handle or grip portion 72 extends from and between the first terminal end 68 to a curved portion 74. From and between the curved portion 74 to the second terminal end 70 is a shaft portion 76. The second terminal end 70 in some aspects is configured to converge in a point 78, which facilitates breaking a ground surface 80 during insertion as described further herein.

The second stake 42 extends from and between a first or one terminal end 82 to a second or opposing terminal end 84. The first stake 42, in some aspects, has a generally L-shaped configuration, which assists with insertion, rotation, and storage as described further herein. In instances of the present invention having an L-shaped configuration as well as other aspects, a handle or grip portion 86 extends from and between the first terminal end 82 to a curved portion 88. From and between the curved portion 88 to the second terminal end 84 is a shaft portion 90. The second terminal end 84 in some aspects is configured to converge in a point 92, which facilitates breaking a ground surface 80 during insertion as described further herein.

An exemplary method of using the ladder stabilizer assembly 12 is now provided with respect to an extension type ladder 12 with the fly section 14 having at least a first enclosed passageway 28A through the rung 24A closest to the bottom terminal end 32, a second enclosed passageway 28B immediately adjacent the first enclosed passageway 28A, a third enclosed passageway 28C immediately adjacent the second enclosed passageway 28B, and a fourth enclosed passageway 28D immediately adjacent the third enclosed passageway 28C. In such a configuration, the first enclosed passageway 28A to the fourth enclosed passageway 28D extend through the first four rungs 24 of the ladder 12 starting nearest the bottom terminal end 32 of the fly section 14.

To assemble or retrofit the ladder 12 described in the immediately adjacent paragraph, the first cross bar 36 is inserted through the first enclosed passageway 28A so that the first terminal end 44 and second terminal end 46 of the first cross bar 36 extends outside the ladder 12. Next, the second cross bar 36 is inserted through the second enclosed passageway 28B so that the first terminal end 56 and second terminal end 58 of the second cross bar 38 extends outside the ladder 12. During assembly, the length that the first cross bar 36 and the second cross bar 38 extend from the ladder 12 is equal such that the first opening 52 of the first cross bar 36 aligns with the first opening 64 of the second cross bar 38, and the second opening 54 of the first cross bar 36 aligns with the second opening 66 of the second cross bar 38. In particular aspects, the first cross bar 36 and the second cross bar 38 both have a length of approximately 24.0 inches, which provides the unique advantage of extending sufficiently beyond the width of the ladder 12 thereby allowing for simpler manipulation of the first cross bar 36 and the second cross bar 38 so that the two may be aligned as described herein. For instance, approximately 3.0 inches of the first cross bar 36 and the second cross bar 38 extend beyond each side of the ladder 12.

A plurality of retention assemblies 94 are attached to the first cross bar 36 and second cross bar 38 on opposing sides of the ladder 12. The first plurality of retention assemblies 94 are configured to hold the first cross bar 36 and the second cross bar 38 in a fixed or static position in relation to the ladder 12. In an exemplary configuration, a first retention assembly 94A is attached adjacent the first terminal end 44 and a second retention assembly 94B is attached adjacent to the second terminal end 46 of the first cross bar 36. In such a configuration, a third retention assembly 94C is attached adjacent the first terminal end 68 and a fourth retention assembly 94D is attached adjacent the second terminal end 70 of the second cross bar 38.

In some aspects, each or some of the plurality of retention assemblies 94 include a spacer 96, a washer 98, and a nut 100. In such arrangements of the present invention, the spacer 96 is placed within the enclosed passageway 28 to occupy the remaining space within the enclosed passageway 28 not occupied by the first cross bar 36 and/or the second cross bar 38. In this way, the spacer 96 prevents the movement of the ladder stabilizer assembly 10 within the free space inside the rung 24. The spacer 98 and the nut 100 are then attached and tightened against the respective side of the ladder 12. In aspects of the ladder stabilizer assembly 10 having threads on the first cross bar 36 and the second cross bar 38, the washer 98 and nut 100 fix the position of the first cross bar 36 and the second cross bar 38 through threaded engagement and also fix the position by direct frictional engagement with opposing sides of the ladder 12.

In some arrangements, a plurality of caps 102 are attached to the ladder stabilizer assembly 10 to prevent harm to an individual coming into contact with the first cross bar 36 and the second cross bar 38. More particularly, one of the plurality of caps 102 is placed on the first terminal end 56 of the first cross bar 36 and others of the plurality of caps 102 are placed on the second terminal end 58 of the first cross bar, and the first terminal end 68 and second terminal end 70 of the second cross bar 38. In some aspects, the plurality of caps 102 are made of rubber or plastic, or other similar cushioning material that allows for flexibility to attach to the ladder stabilizer assembly 10 and thereafter hold a substantially static position without other means of attachment.

The shaft portion 76 of the first stake 40 is then inserted through the first opening 52 of the first cross bar 36 and the first opening 64 of the second cross bar 38 with the point 78 of the first stake 40 most proximate to the bottom terminal end 32 of the ladder 12 in relation to the rest of the first stake 40. This process is repeated with the shaft portion 90 of the second stake 42 with the second opening 54 of the first cross bar 36 and the second opening 66 of the second cross bar 38 so that the point 92 of the second stake 42 is most proximate to the bottom terminal end 32 of the ladder 12 in relation to the rest of the second stake 42. In some aspects, the tolerance between the first stake 40 and the first opening 52 of the first cross bar 36 and the first opening 64 of the second cross bar 38 is 0.0625 inches to limit excess movement while facilitating assembly and use. Likewise, in some instances the tolerance between the second stake 42 with the second opening 54 of the first cross bar 36 and the second opening 66 of the second cross bar 38 is 0.0625 inches. In particular aspects this is accomplished with first stake 40 and the second stake 42 having a diameter of 0.375 inches or approximately 0.375 inches.

During an exemplary use of the ladder stabilizer assembly 10, the ladder 12 is placed at an angle with the anti-slip shoes 34 or bottom terminal end 32 on the ground surface 80 and a top terminal end 104 of the ladder 12 against a wall or other surface 106. Once the ladder 12 is positioned, the handle portion 72 of the first stake 40 is used to apply downward pressure on the first stake 40 driving the point 78 and at least some of the shaft portion 76 into the ground surface 80 thereby providing an anchor to the ladder 12. This process is then repeated with the second stake 42 using the handle portion 86, point 92, and shaft portion 90 of the second stake 42. During these steps of using the ladder stabilizer assembly 10, the first cross bar 36 and the second cross bar 38 guide the first stake 40 and the second stake 42 along a path that substantially aligns with the axis on which the ladder 12 is positioned, extends, and aligns. Additionally, the first cross bar 36 and second cross bar 38 prevent flexing of the first stake 38 and the second stake 40 during insertion as the torque applied is limited by the alignment of the first stake 40 and the second stake 42 through the first cross bar 36 and the second bar 38. While a similar benefit could be obtained with just the presence of the first cross bar 36 or second cross bar 38, the presence of both enhances the degree to which over flexing is prevented and by which alignment is sustained with the ladder 12. To further limit permanently contorting the first stake 40 and the second stake 42, substantially rigid materials, such as various rigid metals, can be used. For instance, in some arrangements, the ladder stabilizer assembly 10 is made of steel.

In some methods of using the present invention, the first stake 40 is inserted sufficiently so that the handle portion 72 of the first stake 40 aligns with the third enclosed passageway 28C. When accomplished, the first stake 40 can be rotated and the shaft portion 76 flexed slightly to insert the handle portion 72 inside the third enclosed passageway. Similarly, the second stake 42 can be inserted sufficiently so that the handle portion 86 of the second stake 42 aligns with the third enclosed passageway 28C. When accomplished, the second stake 42 can be rotated and the shaft portion 88 flexed slightly to insert the handle portion 86 inside the third enclosed passageway 28C. In this way, the potential harm that could be caused by falling on the first stake 40 or second stake 42 is limited in the event that a fall should still occur.

Once inserted, the ladder 12 can be useful with the anchoring and stabilization provided by the ladder stabilizer assembly 10. This includes limiting the movement of the ladder 12 from side to side while staying in engagement with the wall 106 and limiting the ladder 12 from disengaging the wall 106 should the ladder 12 be pulled in a direction away from the wall 106 upon an individual losing their balance.

When the ladder 12 is no longer being used, the first stake 40 and the second stake 42 are retracted using the handle portion 72 of the first stake 40 and the handle portion 86 of the second stake 42, the use of which facilitates removal and can be accomplished by an individual without the use of other tools. Once retracted, in some arrangements, the length of the shaft portion 74 of the first stake 40 is sufficient to align the handle portion 72 with the fourth enclosed passageway 28D of the ladder 12 while raising the point 78 of the first stake 40 above the bottom terminal end 32 or anti-slip shoe 34 of the ladder 12. In doing so, the handle portion 72 can be rotated and inserted into the fourth enclosed passageway 28 and thereby preventing the first stake 40 from moving during transport and storage. Similar steps can be taken with the second stake 42 by inserting the handle portion 72 inside the fourth enclosed passageway 28D opposite the first stake 38. In particular embodiments of the present invention, this unique advantage is accomplished by using a first stake 40 and a second stake 42 that have an overall length of approximately 44.0 to 45.0 inches with a handle portion 70 of the first stake 40 and the handle portion 86 of the second stake 42 each having a length of approximately 4.0 inches and the shaft portion 76 of the first stake 40 and the shaft portion 90 of the second stake 42 having a length of approximately 40.5 inches. In other aspects, the first stake 40 and the second stake 42 are configured to have a length to be received in other rungs 24 while being above the terminal end 32 of the ladder 12.

Therefore, a ladder stabilizer assembly 10 has been provided that works with a variety of ladder types, anchors a ladder in place, increases safety of using a ladder, including while alone, resists rocking and pulling, is easy to transport and store, is removable from a ladder, can retrofit a conventional ladder, is easy to use and improves upon the art.

From the above discussion and accompanying figures and claims it will be appreciated that the ladder stabilizer assembly 10 offers many advantages over the prior art. Although the present disclosure and its advantages have been described in detail, it should be understood that various changes, substitutions, modifications, and alterations can be made herein without departing from the technology of the disclosure as defined by the appended claims. The scope of the present application is not intended to be limited to the particular configurations of the process, machine, manufacture, composition of matter, means, methods and steps described in the specification only expressly stated otherwise. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A ladder stabilizer assembly comprising:
a first cross bar having a first opening and a second opening, wherein the first cross bar is configured to be received through a first rung of a ladder;
a second cross bar having a first opening and a second opening, wherein the second cross bar is configured to be received through a second rung of the ladder;
a first stake rotatably received within the first opening of the first cross bar and the first opening of the second cross bar; wherein the first stake has a first handle portion; and
a second stake rotatably received within the second opening of the first cross bar and the second opening of the second cross bar; wherein the second stake has a second handle portion.

2. The ladder stabilizer assembly of claim 1 wherein the first stake and the second stake each have a generally L-shape formed by a curved portion extending between a shaft portion and the handle portion of the first stake and the second stake, respectively.

3. The ladder stabilizer assembly of claim 1 wherein the first opening of the first cross bar and the first opening of the second cross bar are in alignment; and the second opening of the first cross bar and the second opening of the second cross bar are in alignment.

4. The ladder stabilizer assembly of claim 1 wherein the first cross bar and the second cross bar have substantially the same size and shape.

5. The ladder stabilizer assembly of claim 1 wherein the first stake and the second stake have substantially the same size and shape.

6. The ladder stabilizer assembly of claim 1 wherein the first stake and the second stake each converge to a point, wherein the point is configured to break a ground surface.

7. The ladder stabilizer assembly of claim 1 wherein the first cross bar has a first threaded portion that extends from a first terminal end towards a second terminal end, and a second threaded portion that extends from the second terminal end to the first terminal end.

8. The ladder stabilizer assembly of claim 7 wherein the second cross bar has a first threaded portion that extends from a first terminal end towards a second terminal end, and a second threaded portion that extends from the second terminal end to the first terminal end.

9. The ladder stabilizer assembly of claim 1 further comprising a first retention assembly adjustably connected to adjacent a first terminal end of the first cross bar and a second retention assembly connected adjacent a second terminal end of the first cross bar.

10. The ladder stabilizer assembly of claim 9 further comprising a spacer positioned on the first cross bar and configured to occupy a space between the first cross bar and space within an enclosed passageway of the first rung of the ladder.

11. The ladder stabilizer assembly of claim 9 wherein the first retention assembly comprises a washer and a nut, wherein the nut is adjustably and threadably connected to a threaded portion extending from a first terminal end of the first cross bar.

12. The ladder stabilizer assembly of claim 9 further comprising a third retention assembly adjustably connected to adjacent a first terminal end of the second cross bar and a fourth retention assembly connected adjacent a second terminal end of the second cross bar.

13. The ladder stabilizer assembly of claim 12 wherein the first retention assembly, the second retention assembly, the third retention assembly, and the fourth retention assembly are configured to be affixed in an abutting arrangement against opposing sides of a ladder such that the first cross bar and the second cross bar are retained in a fixed position in relation to the ladder.

14. The ladder stabilizer assembly of claim 1 further comprising one of a plurality of caps attached to each of a first terminal and a second terminal end of the first cross bar, and a first terminal end and a second terminal end of the second cross bar; wherein the plurality of caps comprise a flexible and cushioning material.

15. The ladder stabilizer assembly of claim 1 wherein the first cross bar and the second cross bar have a length of approximately 24.0 inches.

16. The ladder stabilizer assembly of claim 1 wherein the first opening of the first cross bar is configured to receive the first stake with a tolerance of 0.0625 inches between the first stake and the first cross bar.

17. The ladder stabilizer assembly of claim 1 wherein the first stake has a shaft portion that measures between approximately 44.0 inches and 45.0 inches.

18. The ladder stabilizer assembly of claim 17 wherein the first stake has a handle portion having a length of approximately 4.0 inches such that the handle portion is configured to be received within a third rung of the ladder when the first stake is raised above a terminal end of the ladder.
